(19) United States
(12) Patent Application Publication
(10) Pub. No.: US 2013/0053064 A1
(43) Pub. Date: Feb. 28, 2013

(54) METHOD AND APPARATUS FOR DETERMINING HEADING ANGLE IN WIRELESS LAN

(71) Applicants: Kyong-Ha Park, Suwon-si (KR); Sung-Min Park, Gwanak-gu (KR); Hyun-Su Hong, Seongnam-si (KR); Joon-Goo Park, Suseong-gu (KR); Chan-Gook Park, Songpa-gu (KR); Hyun-Hun Cho, Seo-gu (KR)

(72) Inventors: Kyong-Ha Park, Suwon-si (KR); Sung-Min Park, Gwanak-gu (KR); Hyun-Su Hong, Seongnam-si (KR); Joon-Goo Park, Suseong-gu (KR); Chan-Gook Park, Songpa-gu (KR); Hyun-Hun Cho, Seo-gu (KR)

(73) Assignees: SNU R&DB FOUNDATION, Seoul (KR); Samsung Electronics Co., Ltd., Suwon-si (KR)

(21) Appl. No.: 13/601,946

(22) Filed: Aug. 31, 2012

(30) Foreign Application Priority Data
Aug. 31, 2011 (KR) 10-2011-0087833

(51) Int. Cl. H04W 24/00

(52) U.S. Cl. 455/456.1

(57) ABSTRACT

A method determines a heading angle of a user terminal in a Wireless Local Area Network (WLAN) system. The method includes examining whether a rotation of a user is detected, upon detecting the rotation, attaining a movement direction vector at a time when the rotation is detected, and attaining the heading angle by using the movement direction vector at the time when the rotation is detected.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Aug. 31, 2011 and assigned Serial No. 10-2011-0087833, the entire disclosure of which is hereby incorporated by reference.

### TECHNICAL FIELD OF THE INVENTION

The present disclosure relates to a pedestrian navigation.

### BACKGROUND OF THE INVENTION

The conventional Global Positioning System (GPS)/Pedestrian Dead Reckoning (PDR) pedestrian navigation system provides location information by using a GPS when the location information based on the GPS is valid, and provides location information estimated by PDR by using an acceleration sensor, a geomagnetic sensor, or the like in a shadow area in which the location information is invalid.

However, the PDR system using the acceleration sensor and the geomagnetic sensor may have an error in direction information due to influence of a pedestrian movement, a surrounding magnetic environment, etc. The direction error may appear as a location information error of the pedestrian, and there is a problem in that a location error diverges when errors are accumulated over time.

### SUMMARY OF THE INVENTION

To address the above-discussed deficiencies of the prior art, it is a primary aspect of the present disclosure is to provide a method and apparatus for determining a heading angle of a pedestrian in a Wireless Local Area Network (WLAN).

Another aspect of the present disclosure is to provide a method and apparatus for determining location information of a user in a WLAN.

Another aspect of the present disclosure is to provide a method and apparatus for determining a heading angle by using a heading angle determination algorithm based on a WLAN in a Global Positioning System (GPS) shadow area and for improving accuracy of a user location by correcting an error of Pedestrian Dead Reckoning (PDR) direction information by the use of the determined heading angle.

In accordance with an aspect of the present disclosure, a method for determining a heading angle of a user terminal in a WLAN system is provided. The method includes examining whether a rotation of a user is detected, upon detecting the rotation, attaining a movement direction vector at a time when the rotation is detected, and attaining the heading angle by using the movement direction vector at the time when the rotation is detected.

In accordance with another aspect of the present disclosure, a user terminal apparatus for determining a heading angle in a WLAN system is provided. The apparatus includes a modem for communicating with another node, a controller for examining whether a rotation of a user is detected by using the modem, for attaining a movement direction vector at a time when the rotation is detected upon detecting the rotation, and for attaining the heading angle by using the movement direction vector at the time when the rotation is detected, and a storage unit for storing signal strength depending on a distance from reference points and signal strength depending on a distance from an Access Point (AP).

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates the concept of estimating a movement direction by using signal strength for Wireless Local Area Network (WLAN) determination according, to an exemplary embodiment of the present disclosure;

FIG. 2 illustrates an algorithm for determining an azimuth in a linear section according to an exemplary embodiment of the present disclosure;

FIG. 3 illustrates an azimuth determination algorithm of a rotation section according to an exemplary embodiment of the present disclosure;

FIG. 4 illustrates a reference point arrangement in a rotation section according to an exemplary embodiment of the present disclosure;

FIG. 5 illustrates a process of rotation detection of a user according to an exemplary embodiment of the present disclosure;

FIG. 6 illustrates a process of an azimuth determination algorithm based on a WLAN according to an exemplary embodiment of the present disclosure; and

FIG. 7 illustrates a block diagram of a user terminal using a WLAN according to an exemplary embodiment of the present disclosure.

### DETAILED DESCRIPTION OF THE INVENTION

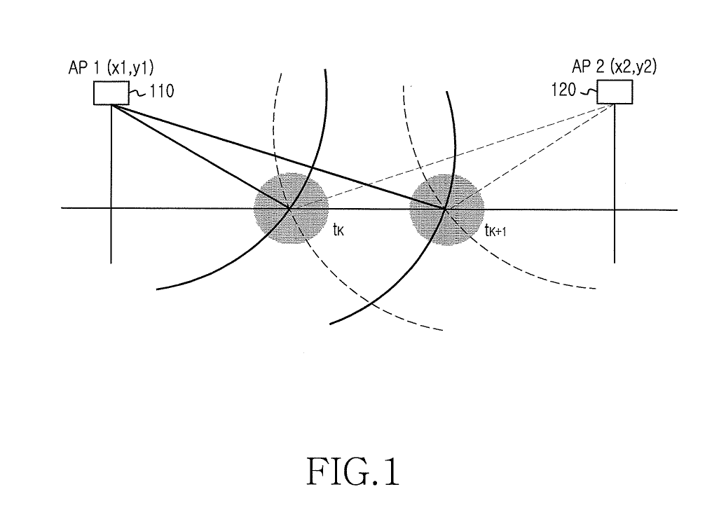

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

Exemplary embodiments of the present disclosure will be described herein below with reference to the accompanying drawings. In the following description, well-known functions or constructions are not described in detail since they would obscure the invention in unnecessary detail. Also, the terms used herein are defined according to the functions of the present disclosure. Thus, the terms may vary depending on a user's or operator's intension and usage. That is, the terms used herein must be understood based on the descriptions made herein.

Hereinafter, a method and apparatus for determining a heading angle in a Wireless Local Area Network (WLAN) will be described.

The present disclosure relates to a pedestrian navigation. More particularly, the present disclosure relates to a method and apparatus for determining a heading angle of a pedestrian in a Wireless Local Area Network (WLAN).

The present disclosure consists of a pedestrian navigation system, a radio navigation system, and an association algorithm. Herein, the radio navigation system may be a Global Positioning System (GPS) and a Wi-Fi Positioning System (WPS), and is a navigation system for providing an absolute coordinate. A GPS/PDR association algorithm will be used for example in the description of the present disclosure.

FIG. 1 illustrates the concept of estimating a movement direction by using signal strength for WLAN determination according to an exemplary embodiment of the present disclosure.

Referring to FIG. 1, a method of estimating a movement direction of a user by using received signal strength of a WLAN terminal carried by the user is illustrated. If there is a positional change as illustrated in FIG. 1 when a time changes from tₖ to tₖ₊₁, signal strength from an AP1 110 is decreased, and signal strength from an AP2 120 is increased.

This can be used to calculate a heading angle and an azimuth of the movement direction of the user. The determined azimuth can be used to estimate the movement direction of the user. The heading direction indicates an angle of the movement direction when the user moves.

In the present disclosure, a WLAN positioning minimum interval is set to about a double of WLAN-based positioning performance in order to consider mobility of the user. This is because the movement direction of the user may be estimated incorrectly due to a positioning error when performing WLAN-based positioning.

In the WLAN-based positioning, positioning of one point is not enough to know the movement direction of the user, and a current proceeding direction may be estimated only when past information and current information are connected. Because of such a characteristic, the movement direction of the user needs to be set to a vector in order to calculate an azimuth by using WLAN-based positioning information.

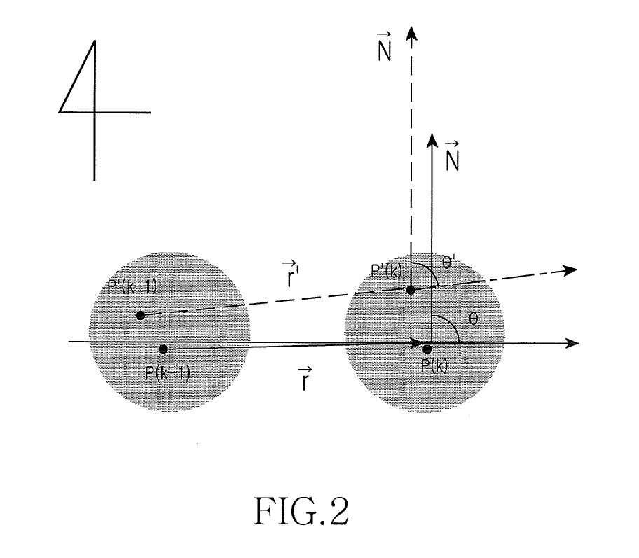

FIG. 2 illustrates an algorithm for determining an azimuth in a linear section according to an exemplary embodiment of the present disclosure.

Referring to FIG. 2, in a method of setting a movement direction vector of a linear section, past and current user locations are estimated in the linear section and the movement direction vector is determined by using two estimated positions.

In FIG. 2, P(k) denotes an actual determination point at a time k, and P′(k) denotes a positioning result at the point P(k). In FIG. 2, a movement direction vector \vec{r} is P(k)-P(k−1), and a positioning movement direction vector \vec{r}′ is P′(k)-P′(k−1).

In this example, a heading angle θ is determined by using an inner product between the movement direction vector \vec{r} and the magnetic north vector \vec{N} according to Equation (1) below.

$$θ = {cos}^{- 1} ( \frac{\vec{{r}^{′}} \cdot \vec{N}}{\vert \vec{{r}^{′}} \vert \vert \vec{N} \vert} ) \qquad ( 1 )$$

Herein, \vec{r}′ denotes a positioning movement direction vector, and \vec{N} denotes a magnetic north vector. Further, θ denotes a heading angle.

In this example, since the heading angle θ obtained using the inner product indicates only an angle against the magnetic north vector \vec{N}, it can be denoted by an azimuth ψ against the magnetic north as expressed by Equation (2) below. That is, the azimuth is indicated in a clockwise direction against the vector \vec{N}.

$$\vec{{r}^{′}} = [ {r}_{x}^{′} , {r}_{y}^{′} , 0 ] , \vec{N} = [ {N}_{x} , {N}_{y} , 0 ] \\ \vec{N} \times \vec{{r}^{′}} = ai + bj + ck \\ \{ \begin{matrix}ψ = 360 - θ , & ( c > 0 ) \\ ψ = θ , & ( c < 0 )\end{matrix} \qquad ( 2 )$$

Herein, \vec{r}′ denotes a positioning movement direction vector, and \vec{N} denotes a magnetic north vector. Further, θ denotes a heading angle, and ψ denotes an azimuth.

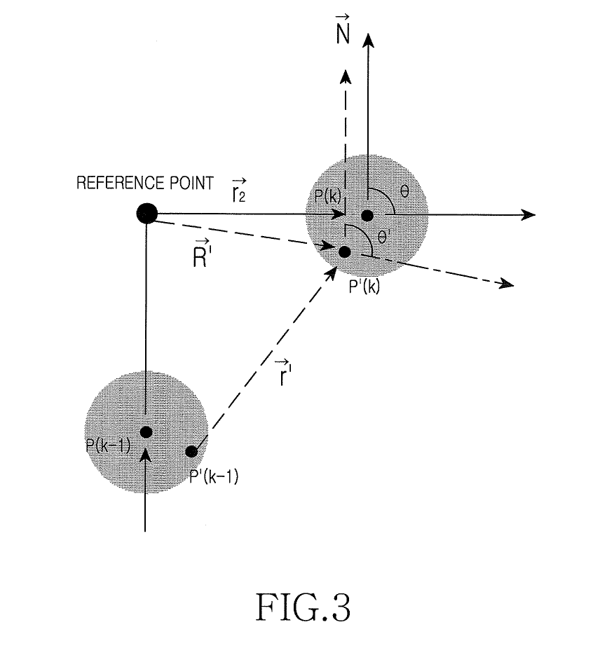

FIG. 3 illustrates an azimuth determination algorithm of a rotation section according to an exemplary embodiment of the present disclosure.

Referring to FIG. 3, positioning is performed at a point k−1 and then a user may rotate before performing positioning at a point k. In this example, if a user movement direction vector is set similarly to a linear section, a movement direction vector \vec{r} cannot properly indicate an actual user movement direction.

In order to solve such a problem, the positioning movement direction vector is modified from a vector \vec{r}′ to a vector \vec{R}′ when a rotation occurs in the middle of positioning.

In FIG. 3, P(k) denotes an actual determination point at a time k, and P′(k) denotes a positioning result at a point P(k). In FIG. 3, a positioning movement direction vector \vec{r}′ is P′(k)−P′(k−1). \vec{R}′ is defined by P′(k)−Pref, and denotes a positioning rotation movement direction vector obtained by considering a rotation direction.

In this example, location information of a reference point and additional information for determining whether a rotation is detected are necessary. When the user rotates, a heading angle θ is determined by re-configuring the movement direction according to Equation (3) below.

$$θ = {cos}^{- 1} ( \frac{\vec{{R}^{′}} \cdot \vec{N}}{\vec{{R}^{′}} \vec{N}} ) \qquad ( 3 )$$

Herein, \vec{N} denotes a magnetic north vector, and \vec{R}′ denotes a positioning rotation movement direction vector obtained by considering a rotation direction. θ denotes a heading angle.

Thereafter, an azimuth ψ is obtained by using the determined heading angle and Equation (2) above.

A rotation detection method using a WLAN signal in a rotation section of the present disclosure will be described as follows. Since a user who approaches to the rotation section has a high probability of changing a movement direction, additional information can be configured in the rotation section and rotation detection can be performed by using this information. Further, the rotation detection can be determined by using WLAN reception signal strength information.

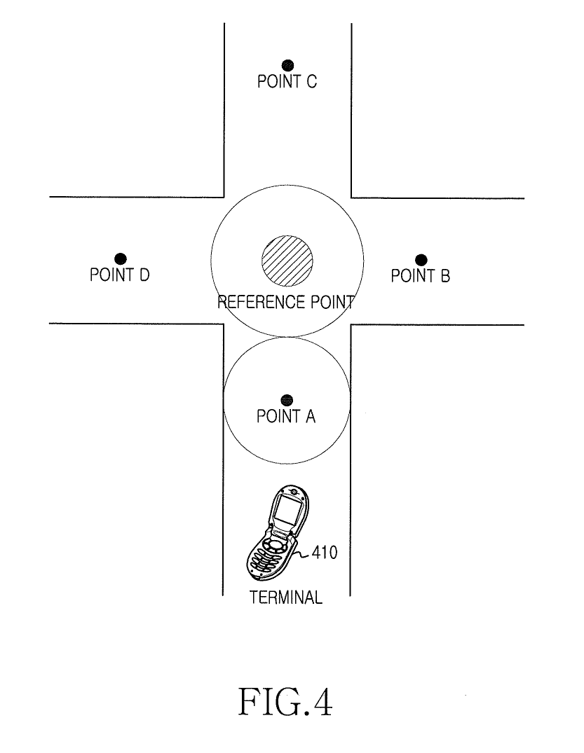

FIG. 4 illustrates a reference point arrangement in a rotation section according to an exemplary embodiment of the present disclosure.

Referring to FIG. 4, reference points (i.e., points A to D) are assigned to respective entrances of rotation sections, and one more center reference point is assigned to the center of the rotation section. The reference points A to D are for rotation detection, and the center reference point is for reconfiguring a movement direction vector when a user movement direction changes.

Location information of the reference points (i.e., points A to D) and received signal strength information determined by using a signal received by a terminal 410 from the AP is stored in a database of the terminal 410 of the user. That is, signal strength depending on a distance from the reference points and signal strength depending on a distance from the AP are stored in the database.

When the user approaches to the reference point A, received signal strength for the AP and determined by the user terminal 410 can be compared with received signal strength information received at the reference point A so as to detect the user who approaches to the rotation section.

Thereafter, signal similarity between the reference point A and the center reference point is recognized. If it is determined that the user is located near the center reference point, the user movement direction is estimated by determining similarity between received signal strength information at the reference points A to D in next positioning and received signal strength determined by the user terminal 410. In this example, mobility of the user can be more correctly recognized by giving some time after detecting the center reference point of the user terminal 410. For example, if received signal strength information from the point A and received signal strength from the center reference point are similar to each other, it can be estimated that the user terminal 410 is located at the same distance from the point A and the center reference point.

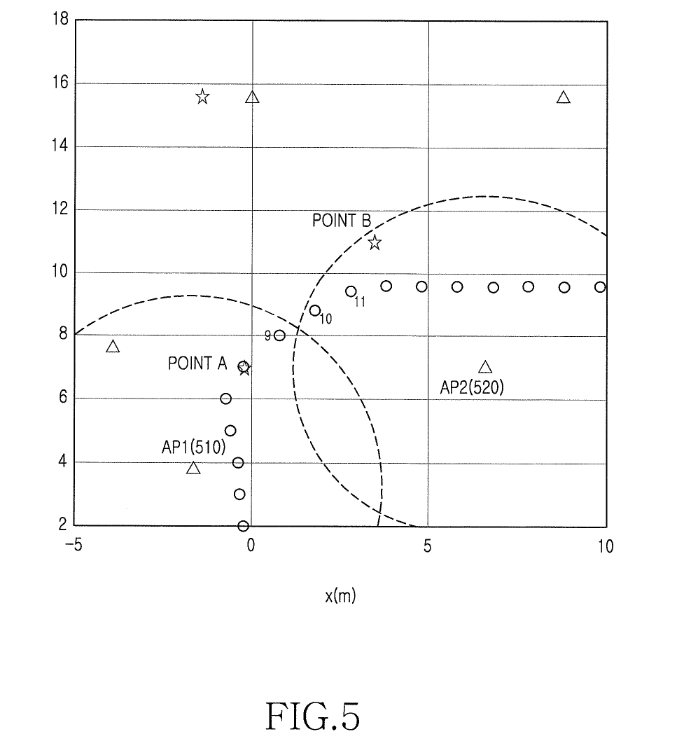

FIG. 5 illustrates a process of rotation detection of a user according to an exemplary embodiment of the present disclosure.

Referring to FIG. 5, a method of using a fingerprint and a cell-IDentifier (ID) is applied when detecting a rotation. The method of using the fingerprint shows a trace of terminal movement as shown in a circle in the figure.

A user terminal can estimate a current location by determining ΔRSSI between a received signal in Condition 1 of Equation (4) below and a candidate location signal stored in a database. However, an error may occur due to signal interference, noise, etc.

For example, a rotation is not fully made at a point 9. However, when a signal determined at the point 9 is used to determine similarity between points A and B, a case where the point 9 is more similar to the point B may frequently occur. To prevent this, Conditions 2 and 3 using the cell-ID are used. By using the Conditions 2 and 3, it is considered that the rotation may only be made when signal strength of the AP1 510 and the AP2 520 is less than (or greater than) or equal to a threshold. It is determined that the user completely rotates when all of the three Conditions of Equation (4) are satisfied.

Condition 1: if ΔRSSIB<ΔRSSIA, it indicates a rotation in a direction B.

$$Δ {RSSI}_{i} = {\sum }_{k}^{ } {( {RSSI}_{k} - \overline{{RSSI}_{ki}} )}^{2} \qquad ( 4 )$$

Herein, RSSIₖ denotes signal strength determined from an APk, and R̅S̅S̅ₖ̅ᵢ̅ denotes signal strength of the APk at a point i stored in a database.

RSSIAP1<Threshold 1 Condition 2

RSSIAP2>Threshold 2 Condition 3

Herein, the AP1 510 is a nearest AP (i.e., an AP that covers a point A) before rotation, and the AP1 520 is a nearest AP (i.e., an AP that covers a point B) after rotation.

In Equation (4) above, when the user rotates from the point A to the point B, ΔRSSI B is less than ΔRSSI A, signal strength determined by the AP1 510 is less than a threshold 1, and signal strength determined by the AP2 520 is greater than a threshold 2.

That is, when the user rotates from the point A to the point B, regarding a rotation direction, an accumulation value for RSSI is less than that of a direction before rotation, a determination value from the nearest AP before rotation is less than the threshold 1, and a determination value from the nearest AP after rotation is greater than the threshold 2.

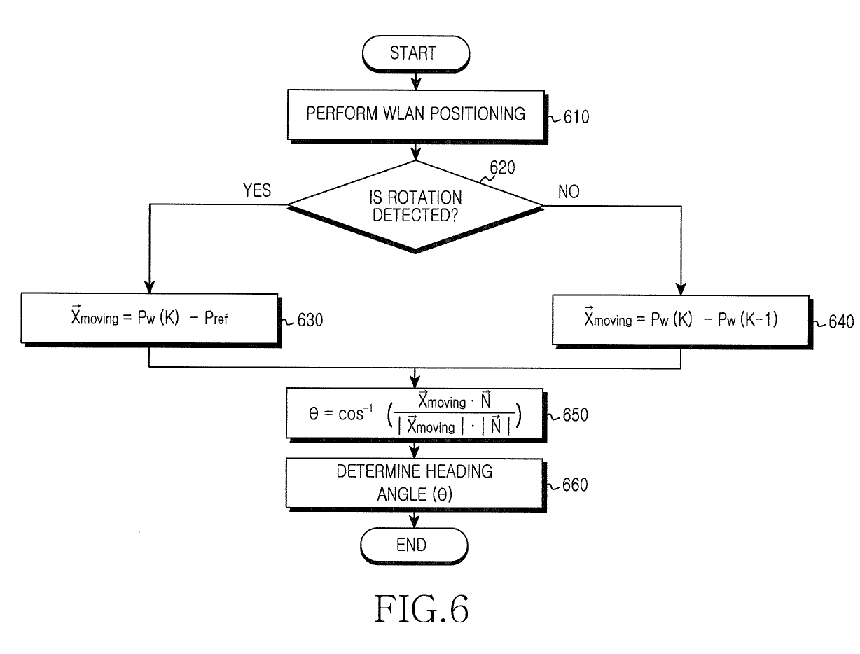

FIG. 6 illustrates a process of an azimuth determination algorithm based on a WLAN according to an exemplary embodiment of the present disclosure.

Referring to FIG. 6, a user terminal performs WLAN positioning at every moment (step 610), and examines whether a rotation is detected (step 620). The aforementioned method described in FIG. 4 and Equation (4) can be used in the examining of whether the rotation is detected.

For example, when the user rotates from the point A to the point B, regarding a rotation direction, an accumulation value for RSSI is less than that of a direction before rotation, a determination value from the nearest AP before rotation is less than a threshold 1, and a determination value from the nearest AP after rotation is greater than a threshold 2.

If the rotation is detected, the user terminal determines a positioning movement direction vector of the user by using the method described above with reference to FIG. 3 and Equations (2) and (3) (step 630). Thereafter, by determining the heading angle (step 650), the heading angle is determined (step S660). In this example, an azimuth can also be determined. Upon detecting the rotation, a movement vector between a location at a current time and a reference location is attained and used as shown in the equation of step 630.

If the rotation cannot be detected, the user terminal determines a positioning movement vector direction of the user by using the method described with reference to FIG. 2 and Equations (1) and (2) (step 640). Thereafter, by determining the heading angle (step 650), and heading angle is determined (step 660). In this example, the azimuth can also be determined. If the rotation cannot be detected, a movement vector between a location at a current time and a reference location at a previous time is attained and used as shown in the equation of step 640.

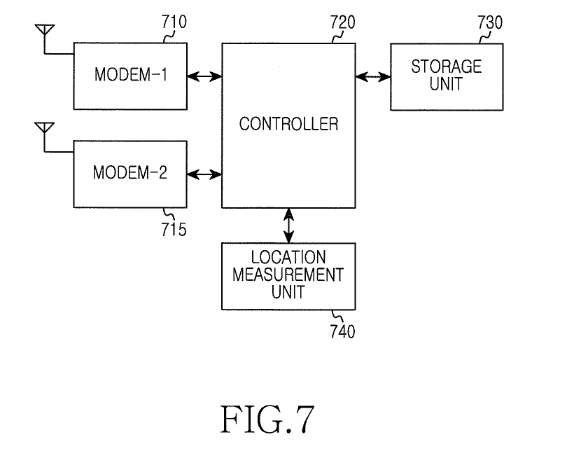

FIG. 7 illustrates a block diagram of a user terminal using a WLAN according to an exemplary embodiment of the present disclosure.

Referring to FIG. 7, the user terminal includes a modem-1 710, a modem-2 715, a controller 720, a storage unit 730, and a location determination unit 740. The controller 720 can control or include the location determination unit 740.

The modem-1 and the modem-2 are modules for communicating with other devices, and include a wireless processor, a baseband processor, etc. The wireless processor converts a signal received through an antenna into a baseband signal and then provides the baseband signal to the baseband processor. Further, the wireless processor converts the baseband signal provided from the baseband processor into a radio signal so that the signal can be transmitted on an actual wireless path, and then transmits the radio signal through the antenna.

All types of currently used wireless communication protocols can be used as a wireless communication protocol used in the modem-1 710 and the modem-2 715. However, since the WLAN is used in the embodiment of the present disclosure, it is determined such that one of the modem-1 710 and the modem-2 715 uses the WLAN.

The controller 720 provides overall control to the user terminal. In particular, the controller 720 controls the location determination unit 740 according to the present disclosure.

The storage unit 730 stores a program for controlling an overall operation of the user terminal and temporary data that is generated while executing the program. In particular, according to the present disclosure, the storage unit 730 stores location information of a reference point (e.g., points A to D) according to the embodiment of the present disclosure and received signal strength information determined from a signal received by the user terminal from an AP.

The location determination unit 740 examines whether the rotation is detected while performing WLAN positioning at every moment. Whether the rotation is detected is determined by using the method described above with reference to FIG. 4 and Equation (4).

If the rotation is detected, the location determination unit 740 determines a positioning movement direction vector of the user by using the method described above with reference to FIG. 3 and Equations (2) and (3). Thereafter, by determining a heading angle, the heading angle is determined. In this example, an azimuth can also be determined.

Upon detecting the rotation, the location determination unit 740 attains and uses a movement vector between a location at a current time and a reference location.

If the rotation cannot be detected, the location determination unit 740 determines a positioning movement direction vector of the user by using the method described above with reference to FIG. 2 and Equations (1) and (2). Thereafter, by determining a heading angle, the heading angle is determined. In this example, an azimuth can also be determined.

If the rotation cannot be detected, the location determination unit 740 attains and uses a movement vector between a location at a current time and a location of a previous time.

It will be appreciated that embodiments of the present disclosure according to the claims and description in the specification can be realized in the form of hardware, software or a combination of hardware and software.

Any such software may be stored in a computer readable storage medium. The computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present disclosure.

Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

According to exemplary embodiments of the present disclosure, a positional error of PDR can be prevented from being accumulated by using an algorithm for detecting a heading angle on the basis of a WLAN, and correct location information of a user can be determined.

Although the present disclosure has been described with an exemplary embodiment, various changes and modifications may be suggested to one skilled in the art. It is intended that the present disclosure encompass such changes and modifications as fall within the scope of the appended claims

What is claimed is:

1. A method for determining a heading angle of a user terminal in a Wireless Local Area Network (WLAN) system, the method comprising:
determining whether a rotation of a user is detected;
upon detecting the rotation, identifying a movement direction vector at a time when the rotation is detected; and
identifying the heading angle using the movement direction vector at the time when the rotation is detected.

2. The method of claim 1, wherein the rotation is detected when:
ΔRSSIB<ΔRSSIA, in case of indicating a rotation in a direction ‘B’, where ΔRSSI is defined as:
$$Δ {RSSI}_{i} = {\sum }_{k}^{ } {( {RSSI}_{k} - \overline{{RSSI}_{ki}} )}^{2} ,$$
where RSSIₖ denotes a signal strength determined from an access point (APk), and R̅S̅S̅I̅ₖ̅ᵢ̅ denotes a signal strength of the APk at a point ‘i’ stored in a database;
RSSIAP1<a first threshold; and
RSSIAP2>a second threshold.

3. The method of claim 1, wherein upon detecting the rotation, identifying the movement direction vector comprises:
identifying a movement vector between a location determined at a current time and a reference location.

4. The method of claim 1 further comprising:
when the rotation is not detected, identifying a movement direction vector at a time when the rotation is not detected; and
identifying the heading angle using the movement direction vector at the time when the rotation is not detected.

5. The method of claim 4, wherein identifying the movement direction vector at the time when the rotation is not detected comprises:
identifying a movement vector between a location determined at a current time and a location determined at a previous time.

6. The method of claim 4, wherein identifying the heading angle at the time when the rotation is not detected uses the following equation:
$$θ = {cos}^{- 1} ( \frac{\vec{{R}^{′}} \cdot \vec{N}}{\vec{{R}^{′}} \vec{N}} ) ,$$
where \vec{N} denotes a magnetic north vector, \vec{R}′ denotes a positioning rotation movement direction vector obtained based on a rotation direction, and θ denotes a heading angle.

7. The method of claim 1, wherein identifying the heading angle at the time when the rotation is detected uses the following equation:
$$θ = {cos}^{- 1} ( \frac{\vec{{r}^{′}} \cdot \vec{N}}{\vert \vec{{r}^{′}} \vert \vert \vec{N} \vert} ) ,$$
where \vec{r}′ denotes a positioning movement direction vector, \vec{N} denotes a magnetic north vector, and θ denotes a heading angle.

8. The method of claim 7 further comprising:
identifying an azimuth using the heading angle at the time when the rotation is detected or at a time when the rotation is not detected.

9. The method of claim 1 further comprising:
performing positioning.

10. The method of claim 1 further comprising:
identifying a position of the user terminal based on the heading angle.

11. An apparatus of a user terminal for determining a heading angle in a Wireless Local Area Network (WLAN) system, the apparatus comprising:
a modem configured to communicate with another node;
a controller configured to identify whether a rotation of a user is detected using the modem, identify a movement direction vector at a time when the rotation is detected upon detecting the rotation, and identify the heading angle using the movement direction vector at the time when the rotation is detected; and
a storage unit configured to store a signal strength based on a distance from reference points and a signal strength depending on a distance from an Access Point (AP).

12. The apparatus of claim 11, wherein to detect the rotation, the controller is further configured to detect the rotation when:
ΔRSSIB<ΔRSSIA, in case of indicating a rotation in a direction ‘B’, where ΔRSSI is defined as:
$$Δ {RSSI}_{i} = {\sum }_{k}^{ } {( {RSSI}_{k} - \overline{{RSSI}_{ki}} )}^{2} ,$$
where RSSIₖ denotes signal strength determined from an access point ‘k’ (APk), and R̅S̅S̅I̅ₖ̅ᵢ̅ denotes signal strength of the APk at a point ‘i’ stored in a database;
RSSIAP1<a first threshold; and
RSSIAP2>a second threshold.

13. The apparatus of claim 11, wherein upon detecting the rotation, the controller is further configured to identify a movement vector between a location determined at a current time and a reference location.

14. The apparatus of claim 11, wherein when the rotation is not detected, the controller is further configured to identify a movement direction vector at a time when the rotation is not detected, and identify the heading angle using the movement direction vector at the time when the rotation is not detected.

15. The apparatus of claim 14, wherein to identify the movement direction vector at the time when the rotation is not detected, the controller is further configured to identify a movement vector between a location determined at a current time and a location determined at a previous time.

16. The apparatus of claim 14, wherein the controller is further configured to identify the heading angle at the time when the rotation is not detected using the following equation:
$$θ = {cos}^{- 1} ( \frac{\vec{{R}^{′}} \cdot \vec{N}}{\vec{{R}^{′}} \vec{N}} ) ,$$
where \vec{N} denotes a magnetic north vector, \vec{R}′ denotes a positioning rotation movement direction vector obtained by considering a rotation direction, and θ denotes a heading angle.

17. The apparatus of claim 11, wherein the controller is further configured to identify the heading angle at the time when the rotation is detected using the following equation:
$$θ = {cos}^{- 1} ( \frac{\vec{{r}^{′}} \cdot \vec{N}}{\vert \vec{{r}^{′}} \vert \vert \vec{N} \vert} ) ,$$
where \vec{r}′ denotes a positioning movement direction vector, \vec{N} denotes a magnetic north vector, and θ denotes a heading angle.

18. The apparatus of claim 17, wherein the controller is further configured to identify an azimuth using the heading angle at the time when the rotation is detected or at a time when the rotation is not detected.

19. The apparatus of claim 11, wherein the controller is further configured to perform positioning.

20. The apparatus of claim 11, wherein the controller is further configured to identify a position of the user terminal based on the heading angle.
